(19) United States
(12) Patent Application Publication
(10) Pub. No.: US 2003/0221123 A1
(43) Pub. Date: Nov. 27, 2003

(54) System and method for managing alert indications in an enterprise

(76) Inventor: John B. Beavers, McLean, VA (US)

Correspondence Address: GUNNISON, MCKAY & HODGSON, L.L.P., 1900 GARDEN ROAD, SUITE 220, MONTEREY, CA, 93940, US

(21) Appl. No.: 10/082,235

(22) Filed: Feb. 26, 2002

(51) Int. Cl. G06F 11/30

(52) U.S. Cl. 713/201

(57) ABSTRACT

A system and method for managing alert incidents or indications in an enterprise processes information about the enterprise using tables, databases, and rules to determine whether the information is worthy of declaring an incident for action to be taken. The inputted information is filtered and throttled using the rules, decision tables, databases and defaults to display the incident in a useful format that shows a defined conclusion for analysis.

### FIELD OF THE INVENTION

The present invention is directed to a system and method for managing alert indications in an enterprise, and in particular to a system and method which employs rules, databases, decision tables and default processing to manage the alert indications for action.

### BACKGROUND ART

In the prior art, it is common to use a number of different types of devices to monitor enterprises, particularly network enterprises. A firewall device is one example of a device that is used to protect against unauthorized access into intranet and internet-based networks. Other devices may relate to routers, both internal and external, servers, both internal and external, Intrusion Detection Software, wireless machines such as laptops, modems, and the like.

In many instances, these various devices monitor security-related threats and events and produce an output or stream of audit information, i.e., security events or alerts. These streams are received by a centralized information manager, which then normalizes the information and sends the information to a security administrator.

One problem with these systems is that the security administrator is overloaded by the number of security events that are sent from the information manager. FIG. 1 illustrates such a scenario wherein a multitude of events 50 from an enterprise, e.g., security events, are sent to an overworked administrator 51. Even when the events 50 are transformed into neatly organized and normalized data 53, see FIG. 2, the administrator is still overworked with a multitude of modified inputs 55.

Secondly, prior art systems do not effectively link different types of devices together to better ascertain the type and/or source of a security event. For example, a security administrator may receive information from a firewall device, as well as a Linux or Windows NT device of an unauthorized logon to a network. The administrator gets two inputs for the same event, thus complicating the administrator's job in ascertaining the threat.

Another problem with these types of systems is that the information from one source alone may not be sufficient to indicate that a problem exists. For example, an enterprise may be interested in monitoring port scans but not those outside the firewall; only those occurring in its internal network. Thus, the port scans outside the firewall may never be passed along. However, from an enterprise level, it may be important to know that internal port scans are occurring at the same time port scans are occurring outside the firewall.

Consequently, a need exists to improve methods and systems used in the prior art to more effectively communicate alerts that occur within a given enterprise and are deserving of action on the part of an administrator.

The present invention solves this problem by managing the number of alert indications using a set of decision tables, rules sets, databases, and default conditions. The method receives the alert indications uses the tables, and rules to determine whether an incident should be declared. The method and system are capable of remembering the alert indications, and identifying patterns in the remembered information in order to properly declare an incident.

### SUMMARY OF THE INVENTION

It is a first object of the present invention to provide a method of managing a number of alert indications so as to declare an incident based on the alert indications for subsequent viewing and/or action.

Yet another object of the invention is a system, which provides the ability to declare and incident based upon a knowledge base that represents the enterprise administrator's normal methods of correlating and assessing alert streams from a plurality of sources.

One further object of the invention is a system and method which includes default processing to assure declaration of an incident which an enterprise may not be familiar with.

Other objects and advantages of the present invention will become apparent as a description thereof proceeds.

In satisfaction of the foregoing objects and advantages, the present invention provides a method of declaring an incident in an enterprise by providing a number of alert indications containing information concerning an incident related to the enterprise. The alert indications are compared to a set of rules, and if a match occurs between the set of rules and the alert indication, an incident based on the match is declared. In many cases, the rules determine through matching whether the alert indication should be remembered. In addition, if remembered, the alert indication is then used to detect matches with known threat conditions as new and different alerts are received. If a match occurs between the remembered indications and the correlation data, an incident is declared. This approach dramatically reduces the number of false positives presented to the operator, since incidents need not be declared for lower-priority alerts that, in and of themselves, do not necessarily require attention. Alternatively, one or more of the alert indications is compared to a decision table containing a number of defined alert events. The decision table determines through matching whether the alert indication should be remembered. In addition, if remembered, the alert indication is then compared to correlation data in the decision table. If a match occurs between the remembered indications and the correlation data, an incident is declared. If no match occurs with the set of rules or decision table, the alert indication is compared to a set of default values, and an incident is declared if the alert indication passes a threshold value in the defaults. In one mode, the defined default threshold value can be a level of severity in the alert indication. The rules can include customized ones as well as default rules.

Once an incident is declared, an incident ticket can be generated and displayed for each incident. The incident ticket can include a description of the incident, one or more conclusions about the incident, any automated or human-induced actions responsive to the conclusion, one or more incident tracking rules which identify one or more further alert indications for association with the incident ticket, and a detail of the alert indications associated with the incident. The incident ticket can also be followed by a listing of “raw events” that, if requested by the user, contains information that has been left in the native (vendor-specific) format of the original sensor that produced the event.

The method also includes the step of tracking further alert indications once an incident ticket is declared and associating the further alert indications with the incident ticket based on one or more incident tracking rules. As part of this tracking, the associating step can be performed only if the further alert indications pass a threshold value to minimize the number of associations. The incident tracking rules can be automatically updated based on one or more further alert indications or by the operator via the system's user interface.

In a preferred mode, the alert indications include information having a common format so that the decision tables and rules can look for the common format values.

The method and system can be employed with virtually any enterprise, and preferably to a network enterprise with a number of network devices that supply the alert indications for incident declaration.

The invention also encompasses a system for declaring an incident in an enterprise that comprises a decision table containing a number of defined alert events, and a set of correlation data that identifies patterns in alert indications inputted to the decision table. The decision table remembers inputted alert indications matching defined alert events, and declares an incident if a match occurs between remembered alert indications and the correlated data. The set of rules contains a number of query statements, wherein a match between at least one of the rules and the inputted alert indications can result in an incident declaration. A set of default standards is also provided that specify a minimum or threshold value to declare an incident should a match not occur with the decision tables or set of rules.

The system can also display the incident as an incident ticket, wherein the incident ticket can include one or more of a description of the incident, a conclusion based on incident description, any actions responsive to the conclusion, one or more incident tracking rules which identify one or more further alert indications for association with the incident ticket, and a detail of the alert indications associated with the incident.

The system can also employ an alert processing subsystem that tracks inputted alert indications, filters out inputted alert indications that do not meet a threshold value, compares the inputted information to a tracking rule to determine whether the inputted information should be associated with a declared incident. Databases are employed to save the information declared as incidents as well as the alert indications processed for updating of incidents and altering incident tracking rules.

In one preferred mode, the system can be used in conjunction with the internet by linking to customer via a web server.

### BRIEF DESCRIPTION OF THE DRAWINGS

Reference is now made to the drawings of the invention wherein:

FIG. 1 represents a prior art system of monitoring events in an enterprise;

FIG. 2 represents another prior art system of monitoring events in an enterprise;

FIG. 3 is a flow chart showing one mode of the inventive system and method;

FIG. 4 shows a typical incident ticket for a declared incident; and

FIG. 5 is another flow chart depicting the alert processing aspect of the invention; and

FIG. 6 shows a display screen illustrating the tracking update feature of the invention.

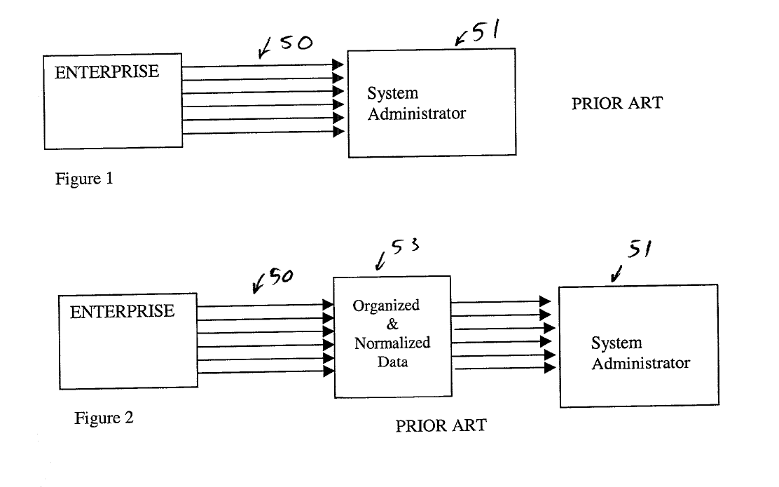

### DESCRIPTION OF THE PREFERRED EMBODIMENTS

One of the significant advantages of the system is the managing of alert indications and the ability to make decisions about whether an incident should be declared by the steps of remembering information about the alert indications and the enterprise, and locking onto patterns in the remembered information that allow the decision making process to take place.

The inventive manager is capable of receiving input information from a number of different sources of information, and this is a significant advantage in sorting out information for alert purposes. For example, information may be received simultaneously relating to firewall breeches, intrusion detection system alerts, etc. The manager is capable of processing this information collectively and outputting a concise description of an incident which an enterprise manager or administrator can then act upon.

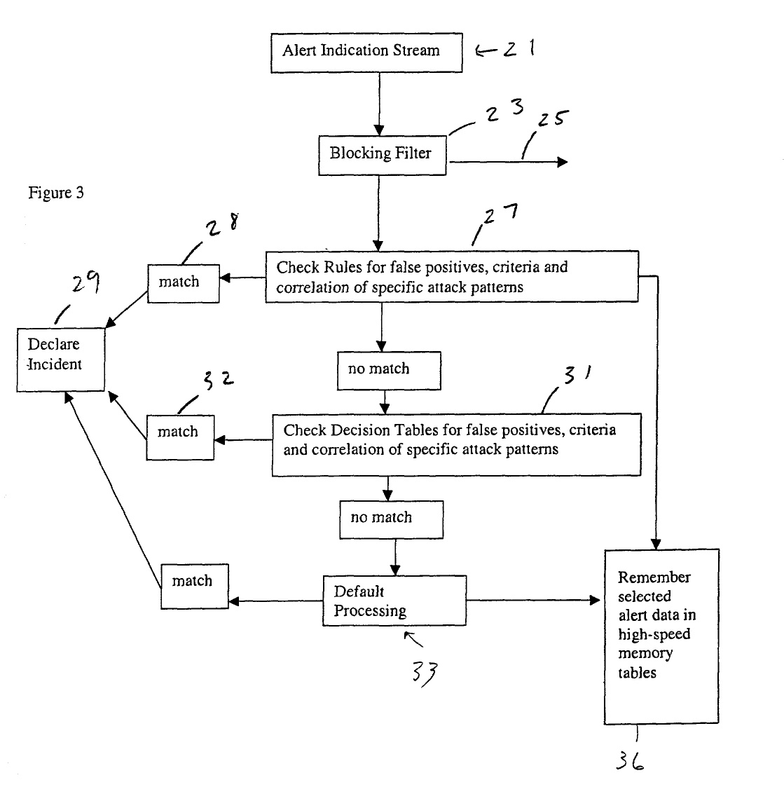

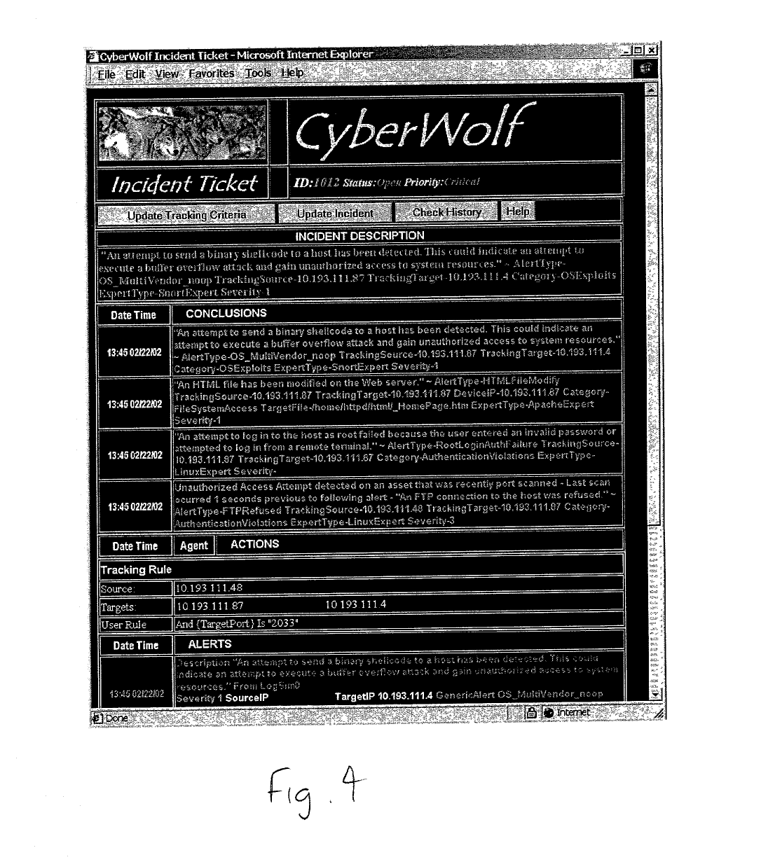

Referring to FIG. 3, a flow chart is depicted describing the steps involved in one aspect of the inventive method and system.

First, an alert indication is provided at 21. This alert indication can take any form, but it is preferred that the form be a common format information containing one or more alert indications as disclosed in applicant's co-pending application entitled “System And Method For Tracking And Filtering Alerts In An Enterprise And Generating Alert Indications For Analysis,” Docket No. 12016-0004, filed on Feb. 25, 2002. The co-pending application is hereby incorporated in its entirety by reference. The common format information containing alert indication is preferred since it eases the steps of checking for false positives and for criteria and correlation with specific attack patterns.

The input 21 can optionally pass through a first filtering step 23. This filtering step can be any basic step to block information that would be considered as noise by the information manager. An example of such noise would be legitimate and routine automated probes that are applied by third-party network management and other systems. If the noise is detected, the information is trashed or diverted at line 25. If no noise or unwanted information match is made at the filtering step 23, the information is passed to the check rule step 27. This step analyzes input 21 to determine if false positives are present, and whether a match at 28 exists for criteria and correlation set forth in the rules which will be described below. This step also causes memorization of patterns that may be emerging from the alert stream that do not immediately result in incident declarations but may result in same as further alerts are received, see box 36 in FIG. 3.

If a match is made, an incident is declared at step 29. As part of the incident declaration, output fields are created resulting from a “deep knowledge” situation of the input 21. That is, based on the fact that a match has occurred between the input and the rules, a fair amount of knowledge is now available concerning the input and how it relates to the data and queries set forth in the rules.

If no match is made at step 27, the input 21 is passed to a Decision Table check step 31 wherein a decision table is used to determine if false positives exist and whether a match exists between criteria in the Decision Tables and the input. If such a match occurs at 32, an incident is declared at step 29.

If no match occurs, the input 21 is sent to a default processing step 33. This step handles alert indications that may be considered serious but have no specific pattern that would be matched in the rule or decision table checking steps. For example, if the alert indication input 21 is assigned a certain type of threat severity such as a 3 on a scale of 1-5 (1 being the highest threat, the default processing steps checks for a match of the incoming threat severity with the default threat. If the default threat is set at 3, a match would occur and an incident would be then declared at step 29.

Once an incident is declared, it can be displayed in any known fashion, including written reports or visual display such as on a computer screen via a web server and a global network, i.e., the internet, or by any of a number of auditory alarms, or by email or pager notifications, or through a server and an internal network. An incident is a correlated collection of alert indications, conclusions, and logged actions take by the system or by the operator. It is akin to a breech in the lines during a battle, something requiring the attention of a field commander. Often times, the incident will be based on more than one alert indication over an extended period of time. An incident may not necessarily be specific to a single device or subnet.

Conclusions are statements of what is believed to be happening in an incident. Answers are provided to questions such as: who is causing the incident; what is going on; where is it happening; when did it happen, and is it ongoing; why is this happening, how is it being done; what is the intent of the perpetrators; and is the incident still ongoing.

Once an incident is declared, an action as a mitigating response can be taken. The action can be automated based on the specific incident declaration or can be performed and recorded by a human in response to an ongoing incident. These actions also document the evolving response to the incident. An example would be to shut down a web server that is suspected of being compromised.

More specifically, the display of the information produced by the manager can take the form of a main screen for viewing the overall security picture, and a listing of the declared incidents. The incidents could be in a table with the time, the status, the threat level, and an incident description. A typical line in the incident list could look as follows:

| | | | | INCIDENT |
|---|---|---|---|---|
| VIEW | TIME | STATUS | THREAT | DESCRIPTION |
| View | 12:01 AM | OPEN | CRITICAL | An attempt to log in to |
| Buttons go | | | | the host as an |
| here (for | | | | administrator failed |
| display of | | | | because the user |
| incident | | | | entered an invalid |
| ticket) | | | | password. This could |
| | | | | indicate an |
| | | | | attempt by a malicious |
| | | | | user to guess the |
| | | | | correct password and |
| | | | | gain administrative |
| | | | | access to the host.” |
| | | | | Device |
| | | | | IP=10.193.111.48 |
| | | | | Target |
| | | | | File+10.193.111.48 |
| | | | | Expert Type |
| | | | | NT Expert |
| | | | | Severity =1 |

Filtering can be employed to select which incidents are displayed in the incident list, e.g., whether it is open, working, timed out or closed for status, and critical, very high, high, medium, and low for the threat column.

An incident ticket can be associated with each incident declaration as shown in FIG. 4. The ticket lists relevant details of the declared incident. It can refresh every so often, preferably every 30 seconds, to ensure that recent information is displayed. The header displays the incident ID, status, and priority or threat as displayed in the incident list. Therein, the highest priority conclusion is displayed followed by a listing of conclusions sorted by priority and age. Under the incident is a table of conclusions associated with the incident, followed by a list of actions taken. The tracking rule for the incident description is also shown as is a listing of the specific alert indications for each incident. The description contained under the alert heading corresponds to the input 21. If desired, a listing of all of the specific alerts indications can be displayed chronologically, or using other selection and sort criteria, in an all alert display. As mentioned above, it is this input information that is processed by the manager to produce the incident declaration using the rule sets, databases, decision tables and defaults.

The great advantage in the method and system is that meaningful information is provided to enterprise personnel so that the appropriate action can be taken. This contrasts with the myriad of information that may be input to an enterprise personnel using prior art systems. The invention provides an efficient way to manage the information coming from a number of device experts so that the proper action can be taken.

The decision table aspect of the invention involves two basic steps. A first step involves enterprise specific analysis wherein alert indicators are designated for correlation. This analysis involves the composition by the operator of a watch list of information, preferably in a format that matches the format of the alert indications. In essence, this watch list identifies the information that should be remembered for possible incident declarations as further significant alerts are received. When an alert indication comes in as input 21 to the decision tables, it is compared to the watch list. If no match occurs, then the input is forwarded for other types of processing. If a match occurs, then the alert is remembered by the automation for later comparison with match patterns that are defined in the Correlation Decision Table.

At this stage, the remembered alert indication can be dealt with in two ways. First, the remembered alert indication can be saved as a list of remembered alert indications. For example, if 50 alert indications are received of the same thing applied from a particular source against a particular target, an alert indication can be remembered once 50 indications occur. Other examples would be to remember certain categories of alerts such as authentication violations, the source IP and the target IP, and any violations that are within a certain time period. Alternatively, each alert indication can be considered to be remembered data.

In either case, the system produces remembered data for further processing as part of the enterprise specific correlation mode of the invention. Here, a user-defined correlation table is provided which stores combinations of remembered data which when present would require declaration of an incident.

More specifically, the decision table can be a spreadsheet that allows the user how to discern patterns that are of interest, and whether to respond to such patterns by declaring an incident.

An example of the watch list decision table is shown below:

TABLE I
Alert Watch List Table

| | | | | | | | |
|---|---|---|---|---|---|---|---|
| | Code | | | At- | Com- | | |
| Code to look | Cate- | What to | Dura- | tri- | pari- | | and/ |
| for | gory | do | tion | bute | son | Value | or |

| | | |
|---|---|---|
| Authentication | remember | 12 |
| Violation | and | hours |
| | filter | |
| Portscans | remember | |
| | and | |
| | filter | |

This table defines the use of remembered information in the decision table logic, wherein certain things are looked for, and determinations are made of what to do when you see them. In this example, the enterprise's goal is to declare a security incident any time it observes the following hits from a single source against an asset, a dozen external port scans and one more authentication failures within a 12 hour period. With this directive and referring to Table 1, the system is told to remember port scans and authentication violations that occur within a 12-hour period, and remember the source ID as well as the target IP. With these instructions, the table will remember who is hitting what asset with authentication violations, no matter how many attackers, and what assets are attacked. The second line of the table remembers the same information relating to port scans.

Once the manager has remembered the alert indications, the correlation tables are used to specify patterns. An example of a correlation table is shown below:

TABLE II
Correlation Decision Table

| | | | | | | Alert | | | Alert | | |
|---|---|---|---|---|---|---|---|---|---|---|---|
| Conclusion | | | | | For | Threat | | | Threat | | |
| Code | Action | | Source | | the | or | | | or | | Min |
| (unique) | Code | Sev. | Scope | Target Scope | same | Category | Code | [symbol] | Category | Code | Cnt |
| Gen. | Declare | 3 | 101.21.22 | 102.12.11.45 | Source | Category | portscans | [symbol] | Category | CGI exploits | 1 |
| Penetration | Incident | | | | | | | | | | |
| Pattern | | | | | | | | | | | |
| Suspicious | Declare | 3 | All | All | Source | Category | portscans | [symbol] | Category | authentication | 1 |
| port scan | Incident | | | | | | | | | violations | |

While not shown, another column could be added that is called “Ordered”. This tells the automation whether the alert pattern has to come in order or whether it could occur in any order and still result in an incident. Valid entries are “Yes or No”.

By default, the alert watch list is built automatically by using the information in the Correlation Decision Table. User entry in the alert watch list overrides automated construction. The advantage of this approach is that less experienced users may need to understand and update only the Correlation Decision Table. Each row in Table II is a complete specification of an incident signature. The second line is the one that is germane to the example of remembering port scans. The correlation table says for this line that if for the same source and target IP you see that there have been at least 10 port scans, and at least one authentication violation, then declare an incident. Don't declare and incident unless the target was in the 102.22.311. *class C subnet.

The information remembered and the pattern recognized is then saved to the appropriate file or database. Other rows with specific criteria can be developed based on acquired knowledge or enterprise requirements. Dozens or hundreds of rows could exist.

The remembered information from the watch list is added to an internal dynamic threat table which is a utility table that is not seen or accessed by the user. The dynamic threat table contains one row per network asset that has been noted to be under possible attack, and as alerts/categories of alerts/threats are noted per the specification in the alert watch list table, these are automatically recorded in the appropriate asset row in the dynamic watch list table for later pattern recognition and possible automated declaration of incidents.

A more detailed description of the aspect of the decision tables is as follows. The following describes the purpose and use of each column in the table.

1. Column 1: “Code To Look For”—this is the alert code, or alert category, or threat code that you wish to note. These can be the alert codes delivered from device experts as explained in applicant's co-pending application, or other codes. Although this field must be unique, multiple conditions for alerts such as “PortScans” can be entered by adding an index number after each instance in proper numeric order. For example, the first column in three of the rows in the table might look like the following:

PortScans 1

PortScans 2

PortScans 3

2. Column 2: “Code Category”—may be “Category”, “Threat”, or “AlertCode”. You can instruct the manager to lock on to different elements of a standard alert message in order to decide whether there is something significant to remember. Alert Codes, Categories of Alert, and Threat codes are preferred standard elements of any properly formatted alert message.

3. Column 3: “What To Do”—specifies the action that the system is to take. “Remember and Filter” means that the automation should note that this type of alert has been received for an asset, but not to declare an incident based purely on the current alert alone. This option is key to the elimination of false positive incident declarations. “Remember” alone will cause the alert to be noted, and will leave default processing for incident declaration based upon alert priority to operate normally. “Filter” will simply cause the alert to be ignored.

4. Column 5: Duration—Specifies the time that this alert should be remembered (acted upon). The system will respect this parameter as long as it has space to do so. If the dynamic threat table grows to more thousands of rows than is allowed for in the configuration parameters found in the rules, then garbage collection procedures could shorten the user's request in order to keep the system from running out of memory (usually not a problem).

5. Column 6 and beyond: Pattern matching specifications—columns following are repeating groups of 4 fields that may be used to specify a rule of any length in a standard format. For example, the following might be filled in to eliminate treatment of alerts from particular hosts:

| | | | And | | | |
|---|---|---|---|---|---|---|
| Attribute | Comparison | Value | Or | Attribute | Comparison | Value |
| {SourceIP} | IsNot | 10.131.44.141 | And | {SourceIP} | IsNot | 10.131.45.* |

A more detailed description of the correlation decision table, column by column, is as follows. The general function of the correlation decision table is to tell the manager what patterns it should be looking for in the alert codes, category codes, and threat codes that it was instructed to remember and associate with affected network assets (information automatically maintained in the “Dynamic Threat Table”).

The purpose and use of each column in the table is described in the following:

1. Column 1: “Conclusion Code”—the unique code that will be assigned to each incident type. The conclusion code is used within Incident Tickets to organize conclusions. Site-specific conclusion codes may be specified as any string that is meaningful and unique.

2. Column 2: “Action Code”—Currently the only value that is acted upon by the automation is “DeclareIncident”. If there is no incident currently open that involves the assets referenced in the current alert being processed by the rule engine, and all of the criteria of the decision table row are met, then a “DeclareIncident” code will cause a new incident ticket to be created. If an incident already exists that the current alert tracks to, then this specification will cause a new conclusion to be added to the existing incident (or to multiple incidents if the current alert tracks to multiple incidents).

3. Column 3: “Severity”—the severity that should be assigned to the incident being declared if all the conditions of this row in the decision table are met. 1 is the worst, 5 is the least bad.

4. Column 4: “Source Scope”—specifies the Source IP address range that this row in the decision table refers to. Wild cards are accepted.

5. Column 5: “Target Scope”—specifies the Target IP address range that this row in the decision table refers to. Wild cards are accepted.

6. Column 6: “For The Same”.—“Target and Source” specifies that all conditions in this row of the decision table must be for the same target and source—in other words, you want to focus on a single attacker's activities on a single victim. “Target” is the other acceptable value, and this says that you want to focus on what is happening to a particular asset, no matter who has attacked it.

7. Column 7 and beyond: Code Type/Code Value/Code Count triplets—any number of triplets that specify the patterns to be matched in order to decide that an incident declaration is appropriate. The “Alert, Threat, or Category” columns specify the type of element in the alert message that has been remembered, the “Code” column specifies the actual code remembered, and the “Cnt” column specifies the minimum trigger count before this row in the decision table will be considered to have fired.

The IM.rule is the master rule file for the rule engine aspect of the invention. It contains two clearly-labeled sections that are identified as user-editable rule sections. These sections are:

1. The “Defines” section, where define statements are used to initialize a few basic configuration variables.

2. The “USER-DEFINED CRITERIA” section where all customer-specific enterprise rules are entered.

The remaining sections of IM.rule are tightly organized boilerplate rules that the user should never touch—rules that are part and parcel of predefined alert correlation behaviors of the system, and additionally a category of rules that control the default processing that the manager applies to all incoming alerts. An example of an available pre-defined alert correlation rule is shown in the example that follows. This approach does not use the simplified and less powerful approach of composing “decision tables” just described. In this example, the rule set memorizes the fact that scan alerts have occurred from various sources against various targets, but only declares an incident if additional alerts characterized as “exploits” are also detected for a source/target pair that has already been scanned. Whether an alert is considered an exploit is determined via lookup in a user-editable data table that stores various attributes for selected alerts or alert types.

[image]

Many rules such as the set shown above use high-speed access data tables which are native to the rule engine. Decision tables are only one application of rule engine tables; such tables can also be used for storage of static enterprise data, or for temporary storage of highly-changeable context data that is created and manipulated programmatically. Rule engine tables provide easy to use, yet extremely powerful methods for storing static enterprise data that may be loaded from text files (such as lists of IP addresses that are associated with known attackers). In addition, rule engine tables provide easy methods for automated storage of dynamic data for such purposes as remembering that a particular target network device has been scanned by a possible attacker within a set time limit. This sort of dynamic memorization of enterprise context information is an extremely important element needed to support near-real-time correlation and consequent detection of incidents.

The IM.rule file may be edited using any text editor, however, an evaluation version of the “TextPad” text editor is preferred along with configuration files that cause rule and other files to be displayed with highly-readable color emphasis on various rule components. The IM.rule file may be edited to represent both simple rules and also to implement rules that capture virtually any reasoning process that a person can easily write down in normal English.

The following shows an example of the “Defines” section of the IM.rule file:

```
# = = = = = = = = = = = = = = = = = = = = = = = = = = = = = = = = = = = = =
# DEFINES - useful enterprise and other constants. Defines happen only once
at run time.
# - - - - - - - - - - - - - - - - - - - - - - - - - - - - - - - - - - - - - -
      # Decide whether to start with NEW_TABLE table or SAVED_TABLE when the
      # Information Manager (CyberWolf Manager) restarts.
      Define RESTART_TRACKING_TABLE_SOURCE as SAVED_TABLE
      #Used in true/false comparisons.
      Define True as 1
      Define False as 0
      #Used to allow initialization procedures to execute only once.
      Define FirstPassFlag as 1
      #Default minimum incident declaration threshold for otherwise
      uncorrelated alerts.
      Define INCIDENT_THRESHOLD 4
# = = = = = = = = = = = = = = = = = = = = = = = = = = = = = = = = = = = = =
```

This section is right at the top of IM.rule. The most significant state variable definition shown is the one at the bottom, the INCIDENT_THRESHHOLD. This is the standard threshold for default processing, i.e., default processing will only declare new incidents for alerts that have severities lower than (more serious than) the value specified in this line of IM.rule. The user is free to define his/her own variables here. None of the variables shown should be edited during normal operations.

The criteria below show the other User-Editable section of the IM.rule file. This section of the rule file will be executed by the rule engine every time an alert comes into the system. In this section the user is free to enter as many rules as he/she wishes to define enterprise policies for either:

Filtering alerts in order to stop false positives, or

Recognizing specific conditions under which incidents should be declared.

The USER-DEFINED CRITERIA section in the IM.rule file can be found by using the find function of your text editor and matching on the string “@USER”.

```
# = = = = = = = = = = = = = = = = = = = = = = = = = = = = = = = = = = = = = =
# USER-DEFINED CRITERIA for declaring (adding to) and incident are here.
# - - - - - - - - - - - - - - - - - - - - - - - - - - - - - - - - - - - - - -
#˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜
˜˜˜˜˜˜˜˜˜˜˜˜˜˜˜˜˜˜˜˜˜
# SET UP STATE VARIABLES for later checking with rules based upon
content of current alert.
#˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜
˜˜˜˜˜˜˜˜˜˜˜˜˜˜˜˜˜˜˜˜˜
# Initialize useful flags.
Execute
    Assign BadGuyFlag False;
EndExecute
#˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜
˜˜˜˜˜˜˜˜˜˜˜˜˜˜˜˜˜˜˜˜˜
# ACME CORP. POLICY IMPLEMENTATION: Ignore port scans from our System
    Administration Team.
#˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜
˜˜˜˜˜˜˜˜˜˜˜˜˜˜˜˜˜˜˜˜˜
If (SourceIP) is 122.31.311.11* then
    GoalState;
EndIf
#˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜
˜˜˜˜˜˜˜˜˜˜˜˜˜˜˜˜˜˜˜˜˜
# ACME CORP. POLICY IMPLEMENTATION: Declare an incident if you get ANY
alert # from a source that is on the bad guy list (or add to an existing
incident, which is what DECLARE_STANDARD_INCIDENT does if the alert
tracks to an existing incident).
    #˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜˜
    ˜˜˜˜˜˜˜˜˜˜˜˜˜˜˜˜˜˜˜˜˜
    If BadGuyName=Table (“GetValue”, “BadGuyList”, %Source, 1) IsNot “null”
    and
        BadGuyName IsNot “nullRow” and BadGuyName IsNot “BadTableName” then
        Assign BadGuyFlag True;
        BuildString CUSTOMIZED_INCIDENT_CODE “BadGuyList-” %GenericAlert;
        BuildString CUSTOMIZED_INCIDENT_DESCRIPTION “FROM BAD
        GUY IP (Name-
        “ BadGuyName ”) ”;
        Assign CUSTOMIZED_INCEDENT_PRIORITY=0;
        UseRuleSet DECLARE_STANDARD_INCIDENT;
        GoalState;
    EndIf
# If none of the ACME rules have specified a “GoalState” yet, then processing
falls through from
# here to default alert processing rule sets below:
# = = = = = = = = = = = = = = = = = = = = = = = = = Incident table management.
```

Whatever ingenious rules are contrived for entry into the “USER-DEFINED CRITERIA” section, several basic considerations should always be kept in mind.

All of the rules in the section should be written such that, if no specific conclusion is reached about the current alert, processing will fall through the entire section to sections of the IM.rule file that are below which support all-important default-processing functions.

If alerts are filtered in this section then they will not be available for use in either default processing sections or for Decision Table based reasoning described earlier in this manual.

It should be understood that the invention is not limited to the examples described above, and other criteria can be used, as well as other formats for specifying the rules.

As noted in FIG. 3, the invention uses two mechanisms for processing of the alert indications into an incident. It should be understood that the decision table or the rules set alone could each be used with the default processing.

The advantage of the default processing is that it is a safeguard for the system. That is, the rules set and decision tables relate to information that say that the alert indication is bad and an incident is declared. The problem with this system alone (without a default system) is that if you have not addressed an alert indication either in the rule set or the decision tables, i.e., no match is made, then the system would say that the alert indication is not worthy of an incident declaration. However, it could be that, in fact, the alert indication is bad, just that it is a new type of bad for which knowledge has not been obtained.

The default processing then becomes important since it can address new “bads” until knowledge is acquired. For example, if the alert indication has a severity of 3 on a scale of 1-5, with 1 being the worst, the default processing step could be designed to declare an incident for any alert indication that has a threat severity of 3 or higher, i.e., 1, 2, or 3. Put another way, if the alert indicators derive their information from device experts, the device expert is saying that the alert indication is bad, regardless of whether the rules set of decision tables confirm this. If there is no confirmation, the default processing step still picks up the alert indication as “bad” and declares an alert, even if it is based on shallow information. The administrator can then further investigate the particulars of the incident to determine what action if any is merited.

The invention is also advantageous in that it combines a set of defaults which can be used by the enterprise until information is acquired which would allow the decision tables and rules to be customized to the particular needs of the enterprise. One other advantage is that the enterprise user does not have to be a programmer to operate the manager. The rules and tables can be driven by a Java program, and the enterprise user need only set up the watch list and correlation tables. The rules set aspect of the invention can also be enterprise specific in that a menu of rules can be developed and used based on the history of the enterprise. Alternatively, a customized list of rules can be developed and used when checking the alert indications.

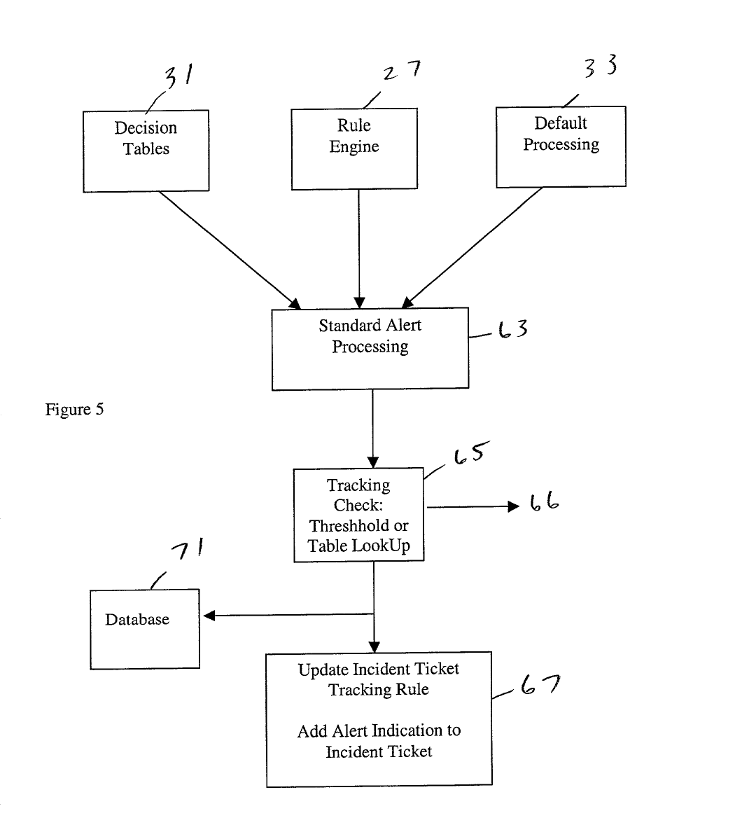

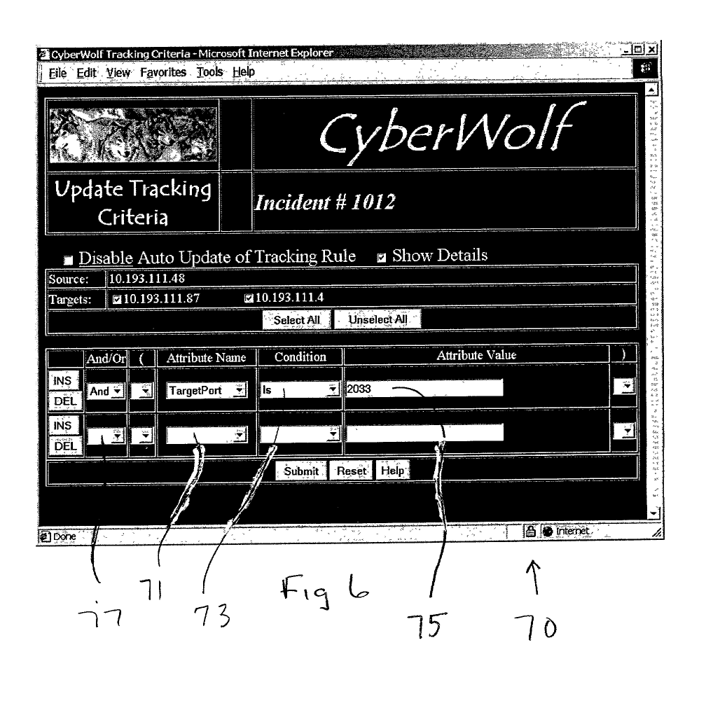

Another aspect of the invention involves an alert processing stream. This aspect takes both non-condition and condition alert information that is received and aggregates the alerts to the appropriate incident ticket based on dynamic tracking of aggressor and target IP addresses for the incident. Referring now to FIG. 5, the flow chart depicts the flow of information in terms of the alert processing stream. In step 27, a non-condition alert stream 61, (one that does not result in a match), is not only sent to step 31 but also to the alert processing step 63. Here, the information is saved to a database, and the information is used to update incidents and tracking rules.

The alert processing stream works in connection with incident ticket and its update tracking criteria feature. This allows the addition of user tracking conditions to the automated tracking rule for the incident. An example of a tracking rule is shown in FIG. 4 under the tracking rule heading. This displayed rule shows that if one of a number of a device, target or source IP's is identified, this alert is associated with the incident ticket. The incident tracking rule consists of a number of logical expressions joined by conjunctions, and display of a set of alert sources and targets that have been automatically detected by the system. The user may override consideration of traffic to and from these sources by de-selecting the checkboxes associated with each. The last expression in the rule should not end in a conjunction. For example, to update a particular incident, one could enter an attribute name, a condition, and attribute value and the conjunction and/or.

Using a pull down menu on the screen, a new rule can be written by the user (as opposed to the default rule created by the automation when the incident was declared) to apply to new alerts. Alert indications meeting the logic in the tracking criteria can then be associated with the incident ticket. FIG. 6 shows a typical updating screen 70, with the various input fields 71, 73, 75, and 77 as described above. In addition, using a “Check History” function available via an action selection in each incident ticket display, the user may command the system to completely redo the aggregation of alerts, conclusions, and description for an incident based upon an updated tracking rule that has been changed to reflect human understanding of possible implications of the incident.

Still referring to FIG. 5, one problem that may be encountered is the generation of a huge number of rules associated with an incident ticket. Consequently, the non-condition alert stream processing step sets a threshold at step 65 which determines whether the non-condition incident should be considered. On-condition alerts are also put through the tracking logic—these are alerts that would result in a new incident, but instead are just added as alerts and conclusions to existing incidents since incidents already exist that incorporate the tracking rule. For example, a threshold may say that if the non-condition or condition alert is a certain type, it should not be appended, or it should not be considered for updating. This acts as a filter or throttle to remove a number of alert indications which would not need to be processed. The information not meeting the threshold is trashed at 66.

If the non-condition alert passes the threshold, this information can be added to existing incident tickets, and the incident ticket tracking rules can be updated with this information as shown in step 67. For example, a non-condition alert indication may indicate that one source that was originally considered not to be a problem but now has suddenly turned into a problem. With this new information, a new tracking rule could be written (see FIG. 6) to include the alert indication with that source IP in the incident ticket. The non-condition alert information can also be stored in database 71.

The tracking rules are kept in a dynamic tracking table, to control updating of the incident tickets with the non-incident alert stream.

While the tracking rules are used to aggregate both non-condition and condition alert indications, the conclusions reached when an incident is declared can also be checked against the incident tracking rules. For example, it may be that an alert indication establishes one declaration incident. This information associated with this incident declaration may also meet a tracking rule for an existing incident ticket. Thus, conclusions are also checked against other incident tickets to determine whether this information may be pertinent to another incident. This is the same check as is made with the non-condition alert indication and whether it applies to an existing declared incident.

Besides updating the tracking rules, the incident ticket itself can be updated by adding a conclusion that may be observed by an enterprise administrator, or adding a new action to be taken, which may also be selected by the user when perusing the incident information.

Another advantage of the method is that it can operate in real time, so that the administrator is being fed information that is current. Key to the real-time functioning of the system is a “distributed intelligence” architecture, wherein the agents, or “device experts” and the centralized manager that accepts alert streams from the agents all have knowledge processing capabilities. Both device experts and the managers that they serve employ a rule engine to implement the distributed intelligent architecture

Although the invention is described principally in terms of security events and alert indications, it is believed that the inventive method and system has utility for any enterprise that has infrastructure elements and devices that receive and send information, wherein monitoring of the information would be valuable for running the enterprise. For example, the enterprise could be a business that operates a number of pieces of machinery and the machinery is monitored for performance. The alerts from this machinery could be processed just as the login alerts described above so that the manager monitoring the machinery is not overwhelmed with useless information. Another example would be a business that operates vehicles, and vehicle locations are monitored. Another example might be application to wartime theaters of operation where leaders need help in lifting “the fog of war”. The inventive method and system are adaptable for virtually any enterprise that has devices that supply information about the enterprise, wherein monitoring of the information is useful in the enterprise operation.

As noted above, the rules set, data, and the decision tables can be used in tandem or alone to analyze the alert indications. However, more knowledge can be input into the rules set than the decision tables and the rules set is believed to be more flexible than the decision tables in terms of processing the alert indications. The reason for this is that there is virtually no limit to the type of information that can be represented in the rules. That is, a number of assets in the enterprise can be addressed. In contrast, the watch list is slightly more restricted since the declaration of an incident is based on the matching of the information in the alert indicator and that identified in the watch list and correlation tables. In terms of order when using both rules and decision tables, either the rules or the decision tables can be used first with the other following second.

One mode of the invention can derive the input information from device experts as detailed in applicant's aforementioned co-pending application.

Device experts are generally semi-autonomous services running somewhere on the enterprise or enterprise network. These devices are considered to be any enterprise infrastructure element capable of receiving and/or sending information over any media, e.g., a network itself, network components, badge readers, etc. Other examples of device experts are:

NT device expert

Solaris device expert

Linux device expert

Raptor Firewall device expert

Snort device expert

Cisco router device expert

HP Openview device expert

NetRanger Intrusion Detection System (IDS) device expert

Often device experts run on the computers they are monitoring (e.g. an NT device expert running on a desktop workstation or NT Server). In some cases, it is not possible to run a device expert on the device it is monitoring, such as a router; in this case the device expert typically runs on a computer that has ready access to the router. Device experts can also be centrally located in instances where it is not feasible or desirable to run the experts on the computers being monitored. Of course besides that coming from device experts, other input as is available can be used in the inventive system and method.

As such, an invention has been disclosed in terms of preferred embodiments thereof, which fulfills each and every one of the objects of the present invention as set forth above and provides an improved method and system for managing alert indications in an enterprise.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. A method of declaring an incident in an enterprise comprising:
providing a number of alert indications containing information concerning an incident related to the enterprise; and either
comparing one or more of the alert indications to a set of rules, and if a match occurs between the set of rules, and the alert indication, declaring an incident based on the match, or
comparing one or more of the alert indications to a decision table containing a number of defined alert events; remembering each alert indication that matches one of the defined alert events, comparing the remembered alert indication to correlation data in the decision table, and if a match occurs between the remembered alert indication and the correlation data, declaring an incident based on the match; or
if no match occurs between the alert indication and the correlation data or the rules set, declare an incident if the alert indication meets a defined default threshold value.

2. The method of claim 1, wherein the defined default threshold value is a level of severity in the alert indication.

3. The method of claim 1, further comprising displaying an incident ticket for each incident declared, the incident ticket including a description of the incident, a conclusion based on incident description, any actions responsive to the conclusion, one or more incident tracking rules which identify one or more further alert indications for association with the incident ticket, and a detail of the alert indications associated with the incident.

4. The method of claim 1, further comprising the step of tracking further alert indications once an incident ticket is declared and associating the further alert indications with the incident ticket based on one or more incident tracking rules.

5. The method of claim 4, wherein the associating step is performed only if the further alert indications pass a threshold value or table lookup from a user-editable table which lists enterprise policy attributes associated with particular alert codes, categories, or threat characterizations.

6. The method of claim 4, further comprising updating the incident tracking rules based on one or more further alert indications.

7. The method of claim 1, wherein the alert indications include information having a common format.

8. The method of claim 1, wherein the enterprise is a network with a number of network devices that supply the alert indications for incident declaration.

9. The method of claim 1, wherein the default defined value derives from a set of rules defining default conditions for declaring an incident.

10. A system for declaring an incident in an enterprise comprising:
a) a decision table containing a number of defined alert events, and a set of correlation data that identifies patterns in alert indications inputted to the decision table, the decision table remembering inputted alert indications matching defined alert events, and declaring an incident if a match occurs between remembered alert indications and the correlated data;
a set of rules containing a number of query statements, wherein a match between at least one of the rules and the inputted alert indications result in an incident declaration; and
a set of default standards specifying a minimum value to declare an incident should a match not occur with the decision tables or set of rules.

11. The system of claim 10, further comprising a display of the incident as an incident ticket, the incident ticket including a description of the incident, a conclusion based on incident description, any actions responsive to the conclusion, one or more incident tracking rules which identify one or more further alert indications for association with the incident ticket, a detail of the alert indications associated with the incident, followed by a listing of “raw events” that, if requested by the user, contains information that has been left in the native or vendor-specific format of the original sensor that produced the event.

12. The system of claim 10, further comprising an alert processing system that tracks inputted alert indications, filters out inputted alert indications that do not meet a threshold value, compares the inputted information to a tracking rule to determine whether the inputted information should be associated with a declared incident.

13. The system of claim 10, further comprising a database for storing at least the declared incidents.

14. The system of claim 12, further comprising a database for storing at least the declared incidents and alert indications passing the threshold value.

15. The system of claim 13, further comprising a web server, linking the system to one or more users via a global network.

16. The system of claim 10, further comprising means for displaying the declared incident.

17. The system of claim 10, wherein the rules are a combination of default rules and customized rules.

18. The system of claim 10, wherein the enterprise is a network and the inputted information is supplied by a number of network devices.

19. The system of claim 12, further comprising an alert processing system that tracks inputted alert indications, filters out inputted alert indications that do not meet a threshold value, compares the inputted information to a tracking rule to determine whether the inputted information should be associated with a declared incident.

20. The system of claim 19, wherein the enterprise is a network, and the inputted information is supplied by a number of network devices.

21. The method of claim 3, comprising updating the incident ticket based an updated tracking rule such that the alert indications, conclusions and description reflect the updated tracking rule.

22. The method of claim 21, wherein the tracking rule is updated using human input based on observations of reported incidents.
